(19) United States
(12) Patent Application Publication
(10) Pub. No.: US 2026/0213662 A1
(43) Pub. Date: Jul. 23, 2026

(54) CONTROL IC OF A MULTIPHASE SWITCHING CONVERTER WITH ACKNOWLEDGMENT CONTROL

(71) Applicant: Chengdu Monolithic Power Systems Co., Ltd., Chengdu (CN)

(72) Inventors: Keke Zhao, Hangzhou (CN); Wangmiao Hu, Hangzhou (CN); Qingqing Zheng, Hangzhou (CN)

(21) Appl. No.: 19/456,873

(22) Filed: Jan. 22, 2026

(30) Foreign Application Priority Data
Jan. 23, 2025 (CN) 202510105151.1

(51) Int. Cl. H02M 3/158

(52) U.S. Cl. CPC H02M 3/1584

(57) ABSTRACT

A power supply system comprises a first plurality of switching circuits, a second plurality of switching circuits, a master control integrated circuit (IC), and a slave control IC. The first plurality of switching circuits connected in parallel and the second plurality of switching circuits connected in parallel are configured to receive an input voltage and provide an output voltage. A first acknowledgment control pin and a second acknowledgment control pin are coupled together to transmit an acknowledgment control signal between the master control IC and the slave control IC. The master control IC is capable of determining the acknowledgment control signal via the first acknowledgment control pin, the slave control IC is capable of determining the acknowledgment control signal via the second acknowledgment control pin. The master control IC and the slave control IC are configured to execute the command in response to the acknowledgment control signal.

### CROSS-REFERENCE TO RELATED APPLICATIONS

This application claims the benefit of CN application 202510105151.1, filed on Jan. 23, 2025 and incorporated herein by reference.

### BACKGROUND OF THE INVENTION

### 1. Field of the Invention

The present invention generally relates to electronic circuits, and more particularly but not exclusively relates to a power supply system and multiphase switching converters.

### 2. Description of Related Art

With the development of high-performance CPUs (Central Processing Units), switching converters with lower output voltage and higher output current are needed, and requirements for better thermal performance and faster transient response are also increasing. Multiphase switching converters are widely used because of their superior performance. A multiphase switching converter has a plurality of switching circuits, each switching circuit being one phase, and output terminals of all the switching circuits are coupled together to provide an output voltage for a load.

A controller for a multiphase switching converter usually provides an individual switching control signal for each phase. However, if the number of the phases is larger than the number of switching control signals that the controller can provide, then it will be necessary to use one switching control signal to control two or more phases, which may cause new problems.

### SUMMARY OF THE INVENTION

It is one of the objects of the present invention to provide a power supply system, a control integrated circuit (IC) of a multiphase switching converter and a control method for a multiphase switching converter.

One embodiment of the present invention discloses a power supply system. The power supply system comprises a first plurality of switching circuits, a second plurality of switching circuits, a master control IC, and a slave control IC. The first plurality of switching circuits are connected in parallel and the second plurality of switching circuits are connected in parallel. The first and second pluralities of switching circuits are configured to receive an input voltage and provide an output voltage. The master control IC comprises a first voltage sense pin, a first plurality of switching control pins, a first communication pin, a second communication pin, and a first acknowledgment control pin. The first voltage sense pin is configured to receive a voltage sense signal representing the output voltage. The first plurality of switching control pins are configured to provide a first plurality of switching control signals based on the voltage sense signal to control the first plurality of switching circuits. The first communication pin is configured to receive a command. The second communication pin is configured to respond to the command. The slave control IC comprises a second voltage sense pin, a second plurality of switching control pins, a third communication pin, and a second acknowledgment control pin. The second voltage sense pin is configured to receive the voltage sense signal. The second plurality of switching control pins are configured to provide a second plurality of switching control signals based on the voltage sense signal to control the second plurality of switching circuits. The third communication pin is configured to receive the command. The first and second acknowledgment control pins are coupled together to transmit an acknowledgment control signal between the master control IC and the slave control IC. The master control IC is capable of determining the acknowledgment control signal via the first acknowledgment control pin, the slave control IC is capable of determining the acknowledgment control signal via the second acknowledgment control pin. The master control IC and the slave control IC are configured to execute the command in response to the acknowledgment control signal.

Another embodiment of the present invention discloses a control IC of a multiphase switching converter. The control IC of the multiphase switching converter comprises a first communication pin, a voltage sense pin, a plurality of switching control pins, and an acknowledgment control pin. The first communication pin is capable of receiving a command. The voltage sense pin is configured to receive a voltage sense signal representing an output voltage of the multiphase switching converter. The control IC is configured to output a plurality of switching control signals via the plurality of switching control pins based on the voltage sense signal to turn on and off a plurality of switching circuits of the multiphase switching converter. The acknowledgment control pin is capable of being coupled to an additional multiphase switching converter to transmit an acknowledgment control signal between the control IC and the additional multiphase switching converter. The control IC sets and reads a state of the acknowledgment control signal via the acknowledgment control pin. The control IC is configured to execute the command in response to the acknowledgment control signal.

Yet another embodiment of the present invention discloses a control method for a multiphase switching converter. The control method for the multiphase switching converter comprises receiving a voltage sense signal representing an output voltage, receiving a command from a system controller, coupling to an additional multiphase switching converter and transmitting an acknowledgment control signal via an acknowledgment control pin, determining whether to execute the command based on the acknowledgment control signal, and providing a plurality of switching control signals to a plurality of switching circuits of the multiphase switching converter based on the voltage sense signal and the command, successively turning on the plurality of switching circuits via the plurality of switching control signals.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically shows a circuit diagram of a power supply system 100 in accordance with an embodiment of the present invention.

FIG. 2 shows a flowchart of a control method 200 for a control integrated circuit (IC) 10_i in response to an acknowledgment control signal Sack in accordance with an embodiment of the present invention.

FIG. 3 shows a flowchart of an operation method 300 for the power supply system 100 in accordance with an embodiment of the present invention.

FIG. 4 shows a communication timing diagram 400 for the power supply system 100 in accordance with an embodiment of the present invention.

FIG. 5 schematically shows a circuit diagram of a multiphase switching converter 100i in accordance with an embodiment of the present invention.

FIG. 6 schematically shows a circuit diagram of a power supply system 600 in accordance with an embodiment of the present invention.

FIG. 7 schematically shows a circuit diagram of a power supply system 700 in accordance with another embodiment of the present invention.

FIG. 8 schematically shows a circuit diagram of the control IC 10_i in accordance with an embodiment of the present invention.

FIG. 9 shows a flowchart of a control method 900 for a multiphase switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

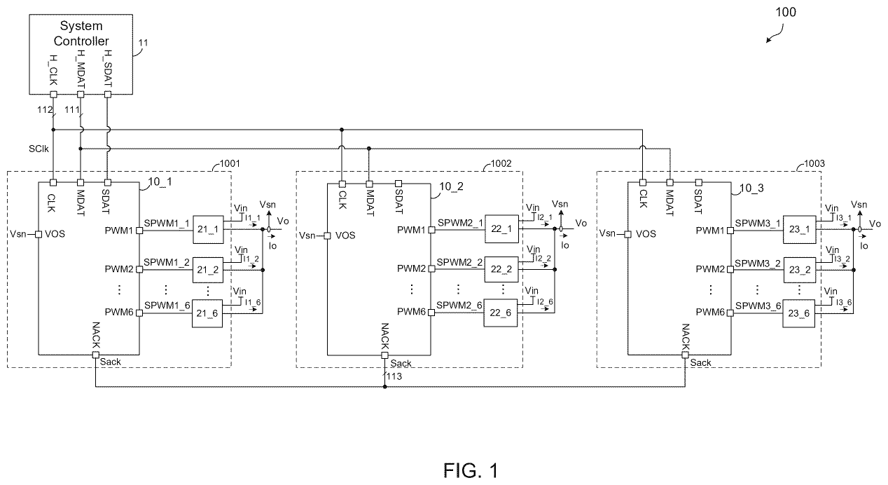

FIG. 1 schematically shows a circuit diagram of a power supply system 100 in accordance with an embodiment of the present invention. The power supply system 100 receives an input voltage Vin and provides an output voltage Vo and an output current Io. The power supply system 100 comprises a plurality of control integrated circuits (ICs) 10_1-10_3 and a power circuit comprising switching circuits 21_1-21_6, 22_1-22_6, and 23_1-23_6 coupled in parallel. The power circuit is configured to receive the input voltage Vin and provide the output voltage Vo. The control IC 10_1 provides a plurality of switching control signals SPWM1_1-SPWM1_6 to turn on and off the switching circuits 21_1-21_6, the control IC 10_2 provides a plurality of switching control signals SPWM2_1-SPWM2_6 to turn on and off the switching circuits 22_1-22_6, and the control IC 10_3 provides a plurality of switching control signals SPWM3_1-SPWM3_6 to turn on and off the switching circuits 23_1-23_6. FIG. 1 is illustrated by employing three control ICs as one example, and one with ordinary skill in the art should understand that the power supply system 100 may also have fewer or more than three control ICs. The control IC 10_1 and the switching circuits 21_1-21_6 form a multiphase switching converter 1001, the control IC 10_2 and the switching circuits 22_1-22_6 form a multiphase switching converter 1002, and the control IC 10_3 and the switching circuits 23_1-23_6 form a multiphase switching converter 1003. In the embodiment of FIG. 1, the switching circuits 21_1-21_6 provides currents I1_1-I1_6 respectively, the switching circuits 22_1-22_6 provides currents I2_1-I2_6 respectively, and the switching circuits 23_1-23_6 provides currents I3_1-I3_6 respectively. In some embodiments, the switching circuits 21_1-21_6, 22_1-22_6, and 23_1-23_6 may comprise buck converters, boost converters or buck-boost converters, etc. One with ordinary skill in the art should understand that each of the control IC 10_i (i=1, 2, 3) may also control more or fewer switching circuits, i.e., the number of switching circuits controlled by each control IC 10_i is not limited by the embodiment of FIG. 1. Furthermore, although each control IC 10_i in the embodiment of FIG. 1 controls a same number of switching circuits, one with ordinary skill in the art should understand that each control IC 10_i may also control different numbers of switching circuits.

In the embodiment shown in FIG. 1, the control ICs 10_1-10_3 are all controlled by a system controller 11. The control IC 10_1 is configured to be a master control IC, and the control ICs 10_2 and 10_3 are configured to be slave control ICs. FIG. 1 is illustrated by employing the two salve control ICs as one example, and one with ordinary skill in the art should understand that the power supply system 100 may also have one slave control IC or more than two slave control ICs. Each control IC 10_i comprises an output voltage sense pin VOS, a clock pin CLK, a communication pin MDAT, and a plurality of switching control pins PWM1-PWM6. The output voltage sense pin VOS of each control IC 10_i is configured to receive a voltage sense signal Vsn representing the output voltage Vo. Each control IC 10_i outputs the plurality of switching control signals via its switching control pins PWM1-PWM6 based on the voltage sense signal Vsn and commands from the system controller 11 to turn on the switching circuits successively. For example, the control IC 10_1 outputs the plurality of switching control signals SPWM1_1-SPWM1_6 via its switching control pins PWM1-PWM6 based on the voltage sense signal Vsn and the commands from the system controller 11 to turn on the switching circuits 21_1-21_6 successively. The control IC 10_2 outputs the plurality of switching control signals SPWM2_1-SPWM2_6 via its switching control pins PWM1-PWM6 based on the voltage sense signal Vsn and the commands from the system controller 11 to turn on the switching circuits 22_1-22_6 successively. The control IC 10_3 outputs the plurality of switching control signals SPWM3_1-SPWM3_6 via its switching control pins PWM1-PWM6 based on the voltage sense signal Vsn and the commands from the system controller 11 to turn on the switching circuits 23_1-23_6 successively. In some examples, the commands from the system controller 11 may comprise enabling and disabling the plurality of switching control signals, adjusting an on-time period of each switching circuit by adjusting the corresponding switching control signal, and setting a target value of the output voltage, etc. In one embodiment, the commands from the system controller 11 further comprise reading present parameters of the power supply system 100, such as reading the output voltage Vo and/or reading the output current Io.

In the embodiment shown in FIG. 1, the clock pins CLK of all the control ICs 10_1-10_3 are coupled to the system controller 11 via a clock bus 112, and receive a clock signal SClk from the system controller 11. The communication pins MDAT of all the control ICs 10_1-10_3 are coupled to the system controller 11 via a data communication bus 111, and receive the commands from the system controller 11, thereby configuring relevant circuit parameters under the control of the system controller 11. In one embodiment, the system controller 11 comprises a clock pin H_CLK and a communication pin H_MDAT. The clock pin CLK of each control IC 10_i is coupled to the clock pin H_CLK of the system controller 11, and the communication pin MDAT of each control IC 10_i is coupled to the communication pin H_MDAT of the system controller 11. In one embodiment, each control IC 10_i further comprises a communication pin SDAT, and the system controller 11 further comprises a communication pin H_SDAT. The communication pin SDAT of the master control IC 10_1 is coupled to the communication pin H_SDAT of the system controller 11. The master control IC 10_1 returns a response message to the system controller 11 in response to each command from the system controller 11. For example, the communication pins SDAT of the slave control ICs 10_1 and 10_2 may be left floating. In another embodiment, the master control IC 10_1 returns the response message to the system controller 11 via the communication pin MDAT. In one embodiment, communication buses may comprise an I2C bus (Inter-Integrated Circuit Bus), a Power Management Bus (PMBus), an SPI (Serial Peripheral Interface) bus, an AVSBUS (Adaptive Voltage Scaling Bus), etc. In one embodiment, the system controller 11 may comprise a baseboard management controller (BMC) or a test controller provided by an IC supplier. One with ordinary skill in the art should understand that each control IC 10_i may also be coupled to the system controller 11 via other communication buses.

In the embodiment shown in FIG. 1, the power supply system 100 further comprises an acknowledgment control bus 113. Each control IC 10_i further comprises an acknowledgment control pin NACK. The acknowledgment control pins NACK of all the control ICs 10_i are coupled together to transmit information between the plurality of control ICs 10_1-10_3. For example, an acknowledgment control signal Sack is transmitted for controlling the plurality of control ICs 10_1-10_3 to execute the commands from the system controller 11. The acknowledgment control pin NACK of the control IC 10_1 is capable of being coupled to an additional multiphase switching converter (e.g. the control IC 10_2 and 10_3) to transmit an acknowledgment control signal Sack between the control IC and the additional multiphase switching converter, the control IC sets and reads a state of the acknowledgment control signal Sack via the acknowledgment control pin NACK. When the plurality of control ICs (e.g., all the control ICs 10_1-10_3), including the master control IC, simultaneously receive one of the commands from the system controller 11, a state of the acknowledgment control signal Sack determines whether these control ICs execute the command and how the master control IC (i.e., the control IC 10_1) responds to the command. In one embodiment, the system controller 11 sends the command to the control ICs 10_1-10_3 via the data communication bus 111 to instruct them to execute the command. The control ICs 10_1-10_3 individually determine whether to execute the received command. Only when all the control ICs 10_1-10_3 determine to execute the command will they all execute the command, and the master control IC 10_1 reports to the system controller 11 that all the control ICs 10_1-10_3 execute the command. Otherwise, none of the control ICs 10_1-10_3 execute the command. In other words, when at least one of the control ICs 10_1-10_3 determines not to execute the command, the other control ICs do not execute the command either, and the master control IC 10_1 reports to the system controller 11 that the control ICs 10_1-10_3 do not execute the command. The Embodiments of the present disclosure stack the plurality of control ICs and connect the plurality of switching circuits in parallel, thereby expanding output ranges. And by transmitting signals via the acknowledgment control bus between the plurality of control ICs to control whether to execute the commands from the system controller, optimizing the system controller's management of the plurality of control ICs, thus enhancing the reliability of the power supply system.

In one embodiment, the system controller 11 sends the command to the control ICs 10_1-10_3, and each control IC 10_i is capable of determining the acknowledgment control signal Sack via its acknowledgment control pin NACK, for example, each control IC 10_i determines whether to execute the command individually, and the state of the acknowledgment control signal Sack is set based on determination results. In the embodiments of the present invention, when the control IC 10_i determines to execute the command, it means that the command can be executed by this control IC. When the control IC 10_i determines not to execute the command, it means that the command cannot be executed by this control IC. When one of the control ICs 10_1-10_3 (e.g., the control IC 10_2) determines not to execute the command, this control IC sets the state of the acknowledgment control signal Sack via its acknowledgment control pin NACK to notify the other control ICs not to execute the command. Specifically, the acknowledgment control signal Sack may be in a first state and a second state. The control ICs 10_1-10_3 execute the command from the system controller in response to the first state of the acknowledgment control signal. When the data communication bus 111 is idle (i.e., the system controller 11 does not send the command to any of the control ICs 10_1-10_3), the acknowledgment control signal Sack remains in the first state. When the system controller 11 sends the command to one or more of the control ICs 10_1-10_3, if the control IC 10_i determines to execute the command, this control IC 10_i does not change the state of the acknowledgment control signal Sack, for example, the acknowledgment control signal Sack remains in the first state. If the control IC 10_i determines not to execute the command, the control IC 10_i sets the acknowledgment control signal Sack to be in the second state via the acknowledgment control pin NACK, i.e., the control IC 10_i transmits the acknowledgment control signal Sack into the second state via its acknowledgment control pin NACK, notifying the other control ICs not to execute the command. In one embodiment, the first state of the acknowledgment control signal Sack may comprise being at a first voltage level, while the second state may comprise being at a second voltage level.

When the system controller 11 sends the command to the control ICs 10_1-10_3, the control ICs 10_1-10_3 monitor the states of the acknowledgment control signal Sack via their acknowledgment control pins NACK starting from a moment that the command is received, and stop monitoring after a preset time period. When the slave control ICs 10_2 and 10_3 start to receive the command from the system controller 11 via their communication pins MDAT, if the acknowledgment control signal Sack remains in the first state within the preset time period, the slave control ICs 10_2 and 10_3 execute the command. If the acknowledgment control signal Sack transitions to the second state within the preset time period as monitored by the slave control ICs 10_2 and 10_3, the slave control ICs 10_2 and 10_3 do not execute the command. When the master control IC 10_1 starts to receive the command from the system controller 11 via its communication pin MDAT, if the acknowledgment control signal Sack remains in the first state within the preset time period, the master control IC 10_1 executes the command and sends an acknowledgment code to the system controller 11, indicating that all the control ICs 10_1-10_3 execute the command. If the acknowledgment control signal Sack transitions to the second state within the preset time period as monitored by the master control IC 10_1, the master control IC does not execute the command and sends an error code to the system controller 11, indicating that all the control ICs 10_1-10_3 do not execute the command.

In one embodiment, for example, reasons for the control IC 10_i determining not to execute the commands from the system controller 11 may comprise: the commands are not successfully received (e.g., due to a data verification), or the commands are successful received but cannot be executed by the control IC 10_i because the control IC 10_i is busy, the commands attempt to write data beyond a valid range, etc.

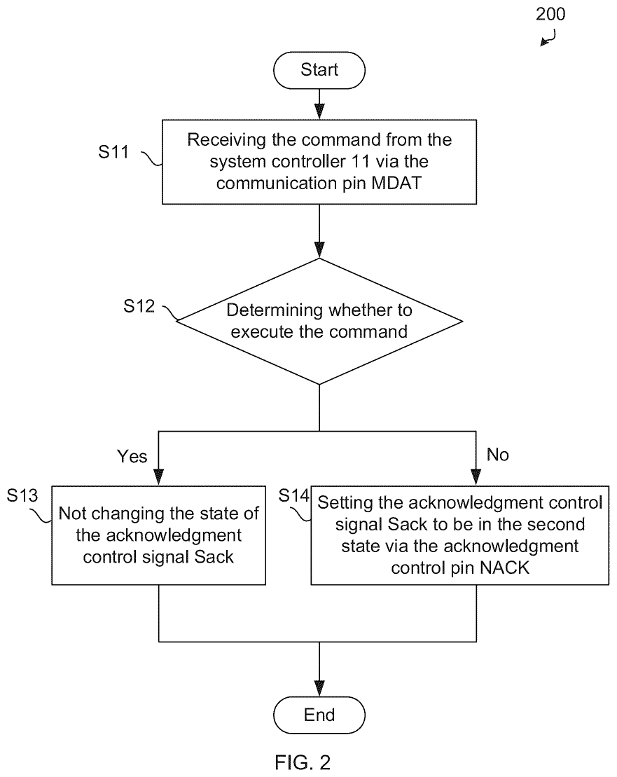

FIG. 2 shows a flowchart of a control method 200 for the control IC 10_i in response to the acknowledgment control signal Sack in accordance with an embodiment of the present invention. In the embodiment shown in FIG. 2, the control IC 10_i is used for the power supply system 100. The control method 200 comprises steps S11-S14.

In the step S11, receiving the command from the system controller 11 via the communication pin MDAT.

In the step S12, determining whether to execute the command. When the control IC 10_i determines to execute the command, proceeding to the step S13; when the control IC 10_i determines not to execute the command, proceeding to the step S14.

In the step S13, not changing the state of the acknowledgment control signal Sack.

In the step S14, setting the acknowledgment control signal Sack to be in the second state via the acknowledgment control pin NACK.

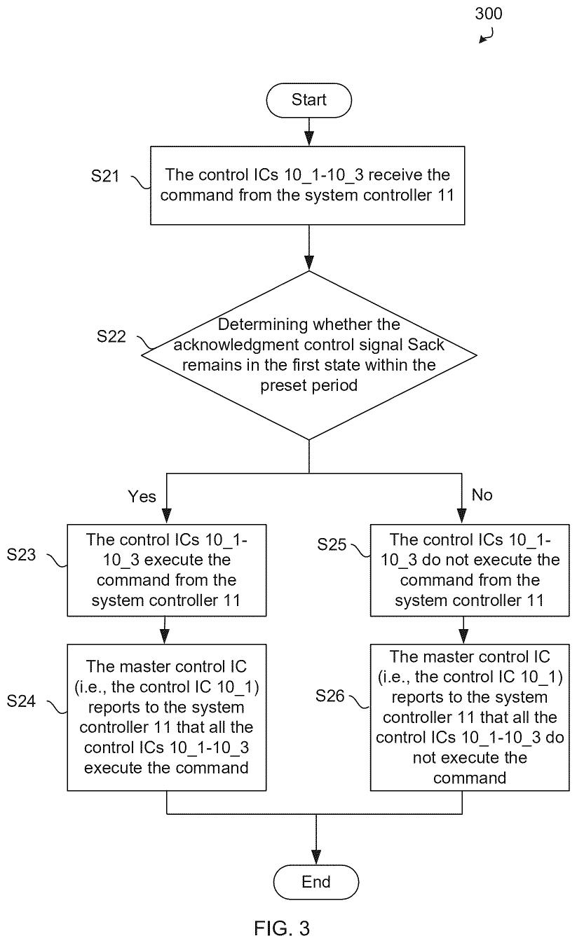

FIG. 3 shows a flowchart of an operation method 300 for the power supply system 100 in accordance with an embodiment of the present invention. The operation method 300 comprises steps S21-S26.

In the step S21, the control ICs 10_1-10_3 receive the command from the system controller 11.

In the step S22, the control ICs 10_1-10_3 monitor the states of the acknowledgment control signal Sack within the preset time period. If the acknowledgment control signal Sack remains in the first state within this preset time period, the steps S23 and S24 are executed; otherwise, the steps S25 and S26 are executed.

In the step S23, the control ICs 10_1-10_3 execute the command from the system controller 11.

In the step S24, the master control IC (i.e., the control IC 10_1) reports to the system controller 11 that all the control ICs 10_1-10_3 execute the command.

In the step S25, the control ICs 10_1-10_3 do not execute the command from the system controller 11.

In the step S26, the master control IC (i.e., the control IC 10_1) reports to the system controller 11 that all the control ICs 10_1-10_3 do not execute the command.

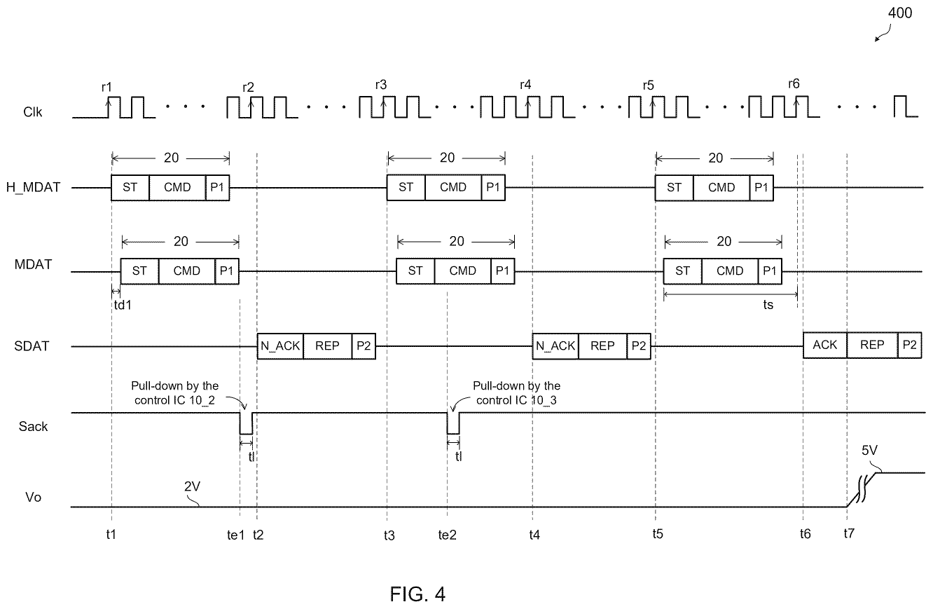

FIG. 4 shows a communication timing diagram 400 for the power supply system 100 in accordance with an embodiment of the present invention. The embodiment shown in FIG. 4 is illustrated by employing the system controller 11 transmitting the command to set the target value of the output voltage as one example, explaining the communication timing between the system controller 11 and the control ICs 10_1-10_3. From top to bottom, FIG. 4 sequentially shows a clock signal Clk, a signal on the communication pin H_MDAT of the system controller 11, a signal on the communication pin MDAT of the master control IC 10_1, a signal on the communication pin SDAT of the master control IC 10_1, the acknowledgment control signal Sack, and the output voltage Vo.

When the system controller 11 attempts to reset the target value of the output voltage Vo, in order to synchronize the control ICs 10_1-10_3, the system controller 11 responds to a first edge (e.g., a rising edge) of the clock signal Clk by simultaneously sending a command 20 to the control ICs 10_1-10_3 to change the target value of the output voltage Vo. Before a moment t1, the data communication bus 111 is idle, and the acknowledgment control signal Sack is in the first state. In the embodiment shown in FIG. 4, the first state of the acknowledgment control signal Sack is logical high, and the second state is logical low. That is, the acknowledgment control pins NACK of the control ICs 10_1-10_3 also have the first state (e.g., logical high) and the second state (e.g., logical low). In one embodiment, a voltage level between a high threshold voltage (e.g., 2V) and a power supply voltage (e.g., 3.3V) is considered the logical high, while a voltage level between zero voltage (0V) and a low threshold voltage (e.g., 1V) is considered the logical low. At the moment t1, the output voltage Vo is 2V, and the system controller 11 responds to a rising edge r1 of the clock signal Clk by sending the command 20 to the control ICs 10_1-10_3 via the communication pin H_MDAT, attempting to change the target value of the output voltage Vo to 5V. In the embodiment shown in FIG. 4, the command 20 comprises a data packet beginning with a start code ST and ending with a check code P1, with a command code block CMD positioned between the start code ST and the check code P1. As illustrated in FIG. 4, the communication pin MDAT of the control IC 10_1 receives the command 20 after a delay td1. Simultaneously, the command 20 is also received by the communication pins MDAT of the control ICs 10_2 and 10_3 (not shown in FIG. 4). The check code P1 may comprise a check correct state and a check incorrect state. When the check code P1 is in the check incorrect state, it indicates that the present data packet is not transmitted correctly. At a moment te1, the control IC 10_2 sets the acknowledgment control signal Sack to be in the second state via its acknowledgment control pin NACK. For example, if the check code P1 received by the control IC 10_2 is in the incorrect state, the control IC 10_2 determines not to execute the command 20 because it fails to successfully receive the command 20. In the embodiment shown in FIG. 4, the control IC 10_2 pulls a voltage level on the acknowledgment control bus 113 low, thus the acknowledgment control signal Sack transitions from the first state to the second state, indicating that at least one control IC determines not to execute the command 20. The acknowledgment control signal Sack remains in the second state for a time period t1 before returning to the first state. In one embodiment, the second state of the acknowledgment control signal Sack is a logic low pulse, e.g., with the period t1 ranging from 20 ns to 10 μs. The control ICs 10_1 and 10_3 monitor the second state of the acknowledgment control signal Sack via their acknowledgment control pins NACK (i.e., each control IC monitors the second state of its corresponding acknowledgment control pin NACK), none of the control ICs 10_1-10_3 execute the command 20. And at a moment t2, the master control IC 10_1 responds to a rising edge r2 of the clock signal Clk by sending an error code N_ACK to the system controller 11, reporting to the system controller 11 that none of the control ICs 10_1-10_3 execute the command 20, thus the output voltage Vo remains unchanged. In one embodiment, the master control IC 10_1 continues to send an acknowledgment code REP and a check code P2 to the system controller 11 after sending the error code N_ACK.

At a moment t3, the system controller 11 responds to a rising edge r3 of the clock signal Clk by sending the command 20 to the control ICs 10_1-10_3 again via its communication pin H_MDAT. At a moment te2, the control IC 10_3 sends the acknowledgment control signal Sack with the second state to the other control ICs via its acknowledgment control pin NACK. For example, the control IC 10_3 determines not to execute the command 20 because it is busy during receiving the command code block CMD. The control IC 10_3 pulls the level on the acknowledgment control bus 113 low, thus the acknowledgment control signal Sack transitions from the first state to the second state, indicating that at least one control IC determines not to execute the command 20. The control ICs 10_1 and 10_2 monitor the second state of the acknowledgment control signal Sack via their acknowledgment control pins NACK (i.e., each control IC monitors the second state of its corresponding acknowledgment control pin NACK), none of the control ICs 10_1-10_3 execute the command 20. At a moment t4, the master control IC 10_1 responds to a rising edge r4 of the clock signal Clk by sending the error code N_ACK to the system controller 11, reporting to the system controller 11 that none of the control ICs 10_1-10_3 execute the command 20 from the system controller 11, thus the output voltage Vo remains unchanged.

At a moment t5, the system controller 11 responds to a rising edge r5 of the clock signal Clk by sending the command 20 to the control ICs 10_1-10_3 again via its communication pin H_MDAT. All the control ICs 10_1-10_3 successfully receive the command 20 and determine to execute it. Within a preset time period ts starting from receiving the command 20, the control ICs 10_1 to 10_3 monitor that the acknowledgment control signal Sack remains at the logic high, that is, each acknowledgment control pin NACK of the corresponding control IC remains in the first state. In the embodiment shown in FIG. 4, the preset time period ts comprises at least a period from a moment when the control ICs 10_i start receiving the command 20 until a next first edge (e.g., the rising edge) of the clock signal Clk after the command 20 arrives at the control IC 10_i. Therefore, at a moment t6, the master control IC 10_1 responds to a rising edge r6 of the clock signal Clk (i.e., a first rising edge of the clock signal Clk after the present command 20 is fully transmitted) by sending an acknowledgment code ACK to the system controller 11, thereby reporting that all the control ICs 10_1-10_3 execute the command 20. At a moment t7, the acknowledgment code ACK transmission is completed, and all the control ICs 10_1-10_3 execute the command 20 from the system controller, thus the output voltage Vo gradually increases to 5V.

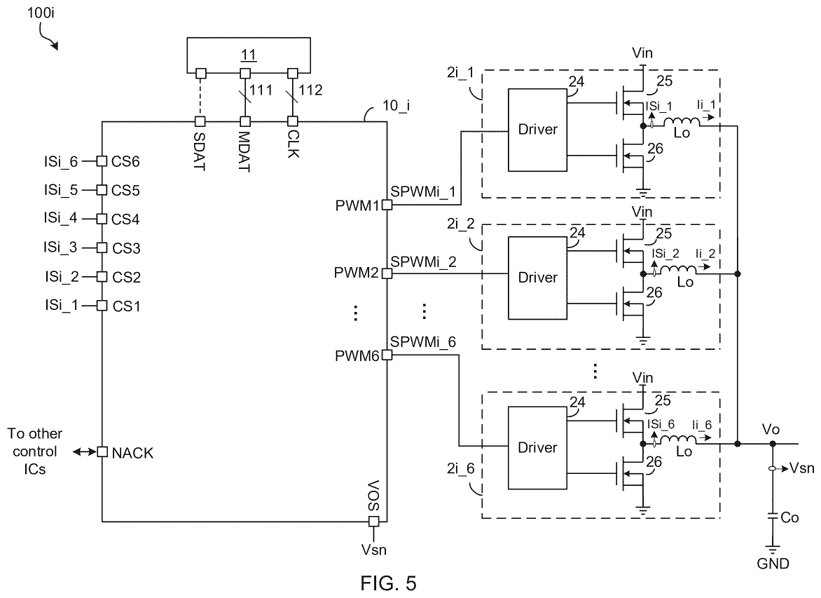

FIG. 5 schematically shows a circuit diagram of a multiphase switching converter 100i in accordance with an embodiment of the present invention. The multiphase switching converter 100i comprises the control IC 10_i and a plurality of switching circuits 2i_1-2i_6. For example, the multiphase switching converter 100i shown in FIG. 5 can be used in the power supply system 100 (where i=1, 2, or 3) shown in FIG. 1. The control IC 10_i is coupled to the system controller 11 via the clock pin CLK and the communication pin MDAT. When configured as the master control IC, the control IC 10_i is further coupled to the system controller 11 via the communication pin SDAT (shown with a dashed line in FIG. 5). In the embodiment shown in FIG. 5, the switching circuits 2i_1-2i_6 are coupled in parallel to provide the output voltage Vo and the voltage sense signal Vsn representing the output voltage Vo. Each of the switching circuits 2i_1-2i_6 comprises a driver 24, a high side switch 25, a low side switch 26, and an output inductor Lo. The high side switch 25 has a first terminal receiving the input voltage Vin and a second terminal coupled to the output inductor Lo. The low side switch 26 has a first terminal coupled to the second terminal of the high side switch 25 and the output inductor Lo, and a second terminal coupled to a reference ground. An output capacitor Co is coupled between the output inductors Lo and the reference ground to provide the output voltage Vo. A current Ii_1 provided by the switching circuit 2i_1 is a current flowing through the output inductor Lo of the switching circuit 2i_1, a current Ii_2 provided by the switching circuit 2i_2 is a current flowing through the output inductor Lo of the switching circuit 2i_2, and so forth, a current Ii_6 provided by the switching circuit 2i_6 is a current flowing through the output inductor Lo of the switching circuit 2i_6. The drivers 24 receive corresponding switching control signals and drive the high side switches 25 and the low side switches 26 to conduct complementarily based on the switching control signals. For example, the driver 24 of the switching circuit 2i_1 drives the high side switch 25 and the low side switch 26 of the switching circuit 2i_1 based on a switching control signal SPWMi_1, the driver 24 of the switching circuit 2i_2 drives the high side switch 25 and the low side switch 26 of the switching circuit 2i_2 based on a switching control signal SPWMi_2, and so forth, the driver 24 of the switching circuit 2i_6 drives the high side switch 25 and the low side switch 26 of the switching circuit 2i_6 based on a switching control signal SPWMi_6. In one embodiment, the driver 24 of each switching circuit 2i_j (j=1, 2, . . . , 6) is integrated in one integrated circuit (IC). In another embodiment, the driver 24, the high side switch 25, and the low side switch 26 of each switching circuit 2i_j are integrated in one IC. In the embodiment shown in FIG. 5, the control IC 10_i further comprises phase current sense pins CS1-CS6 to receive current sense signals ISi_1-ISi_6. Each current sense signal ISi_j represents a current Ii_j flowing through the switching circuit 2i_j, for example, which can be obtained by sensing a current flowing through the output inductor Lo, a current flowing through the high side switch 25, or a current flowing through the low side switch 26.

In one embodiment, when the control IC 10_i is configured as the master control IC, the control IC 10_i provides a current reference data based on the current sense signals ISi_1-ISi_6. This current reference data is provided to the system controller 11 via the communication pin SDAT to regulate output currents of the multiphase switching converters controlled by other control ICs (i.e., the slave control ICs). The system controller 11 transmits the current reference data to other control ICs (i.e., the slave control ICs) via the communication pin MDAT. In one embodiment, when the control IC 10_i is configured as the slave control IC, the control IC 10_i receives the current reference data provided by the master control IC and transmitted by the system controller 11 via the communication pin MDAT, then further provides the plurality of switching control signals SPWMi_1-SPWMi_6 based on the current reference data to regulate an output current of the multiphase switching converter 100i, ensuring that a total current flowing through the plurality of switching circuits controlled by the slave control ICs 10_i balances a total current flowing through the plurality of switching circuits controlled by the master control IC.

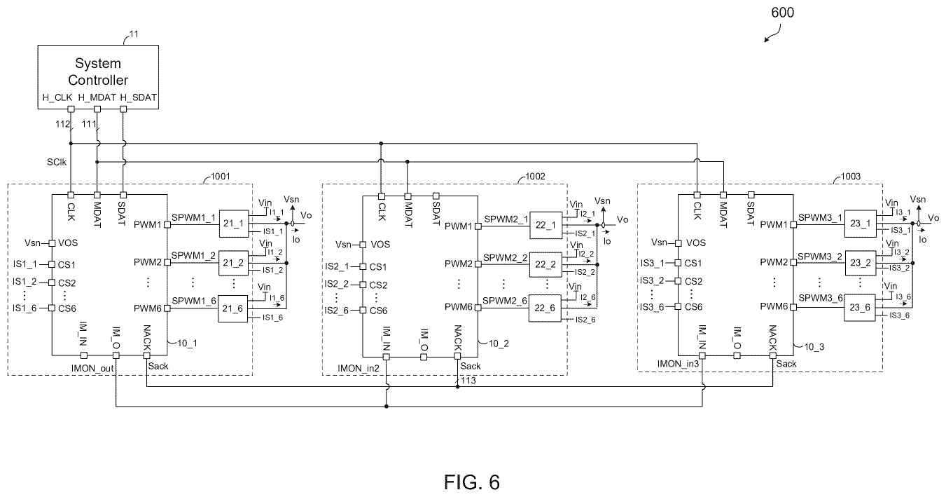

FIG. 6 schematically shows a circuit diagram of a power supply system 600 in accordance with an embodiment of the present invention. FIG. 6 illustrates another embodiment of balancing the total current flowing through the plurality of switching circuits controlled by the slave control ICs with the total current flowing through the plurality of switching circuits controlled by the master control IC. Similar to the power supply system 100 shown in FIG. 1, the power supply system 600 also comprises the plurality of switching circuits 21_1-21_6, 22_1-22_6, and 23_1-23_6 coupled in parallel, a master control IC 10_1, and two slave control ICs 10_2 and 10_3. In the power supply system 600, connections and communications between each control IC 10_i (i=1, 2, 3) and the system controller 11 are identical to those in the power supply system 100 shown in FIG. 1 and not described for clarity. Compared to the power supply system 100 shown in FIG. 1, each control IC 10_i in the power supply system 600 further comprises a current reference pin IM_O and a current feedback pin IM_IN. The current feedback pin IM_IN receives a reference input signal IMON_in, and the current reference pin IM_O provides a reference output signal IMON_out. The control IC 10_i provides a total current signal based on the plurality of current sense signals ISi_1-ISi_6. In one embodiment, the master control IC 10_1 outputs the total current signal via the current reference pin IM_O as the reference output signal IMON_out provided to the other control ICs (i.e., the slave control ICs 10_2 and 10_3). The current feedback pin IM_IN of the slave control IC 10_2 is configured to receive the reference output signal IMON_out provided by the master control IC 10_1, and use this signal as a reference input signal IMON_in2 of the slave control IC 10_2. Similarly, the current feedback pin IM_IN of the slave control IC 10_3 is configured to receive the reference output signal IMON_out provided by the master control IC 10_1, and use this signal as a reference input signal IMON_in3 of the slave control IC 10_3. The slave control IC 10_2 further provides the plurality of switching control signals SPWM2_1-SPWM2_6 based on the total current signal and the reference input signal IMON_in2, the slave control IC 10_3 further provides the plurality of switching control signals SPWM3_1-SPWM3_ 6 based on the total current signal and the reference input signal IMON_in3, ensuring that a total current flowing through the plurality of switching circuits controlled by the slave control IC 10_2, a total current flowing through the plurality of switching circuits controlled by the slave control IC 10_3, and a total current flowing through the plurality of switching circuits controlled by the master control IC 10_1 are balanced.

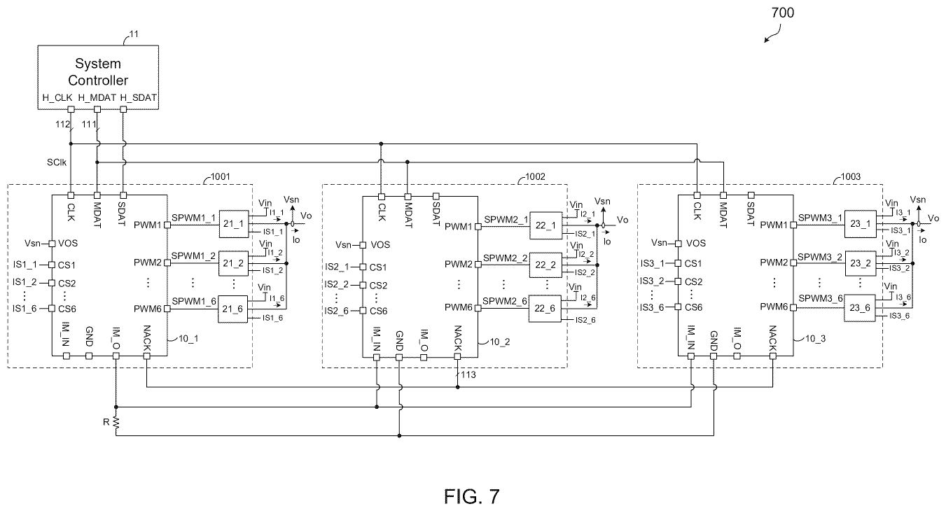

FIG. 7 schematically shows a circuit diagram of a power supply system 700 in accordance with another embodiment of the present invention. FIG. 7 illustrates another embodiment of balancing a total current flowing through the plurality of switching circuits controlled by the slave control ICs with a total current flowing through the plurality of switching circuits controlled by the master control IC. Compared to the power supply system 600 shown in FIG. 6, each control IC 10_i (i=1, 2, 3) in the power supply system 700 further comprises a reference ground pin GND. The main control IC 10_1 provides a first total current signal based on a plurality of current sense signals IS1_1-IS1_6 representing the currents I1_1-I1_6. The slave control IC 10_2 provides a second total current signal based on a plurality of current sense signals IS2_1-IS2_6 representing the currents I2_1-I2_6. The slave control IC 10_3 provides a third total current signal based on a plurality of current sense signals IS3_1-IS3_6 representing the currents I3_1-I3_6. As shown in FIG. 7, the current reference pin IM_O of the master control IC 10_1 is coupled to a resistor R, and outputs the first total current signal across the resistor R, serving as the reference output signals IMON_out provided to the slave control ICs 10_2 and 10_3. The slave control IC 10_2 is coupled to the resistor R to receive the reference output signal IMON_out provided by the master control IC 10_1, serving as the reference input signal IMON_in2 of the slave control IC 10_2. The current feedback pin IM_IN of the slave control IC 10_2 is coupled to a first terminal of the resistor R and the current reference pin IM_O of the master control IC 10_1. The reference ground pin GND of the slave control IC 10_2 is coupled to a second terminal of the resistor R. Similarly, the slave control IC 10_3 is coupled to the resistor R to receive the reference output signal IMON_out provided by the master control IC 10_1, serving as the reference input signal IMON_in3 of the slave control IC 10_3. The current feedback pin IM_IN of the slave control IC 10_3 is coupled to the first terminal of the resistor R and the current reference pin IM_O of the master control IC 10_1. The reference ground pin GND of the slave control IC 10_3 is coupled to the second terminal of the resistor R. The slave control IC 10_2 further provides the plurality of switching control signals SPWM2_1-SPWM2_6 based on the second total current signal and the reference input signal IMON_in2, the slave control IC 10_3 further provides the plurality of switching control signals SPWM3_1-SPWM3_6 based on the third total current signal and the reference input signal IMON_in3, ensuring that the total current flowing through the plurality of switching circuits controlled by the slave control ICs and the total current flowing through the plurality of switching circuits controlled by the master control IC are balanced.

The embodiments shown in FIG. 6 and FIG. 7 are illustrated by employing one master control IC and two slave control ICs as examples. One with ordinary skill in the art should understand that the power supply systems 600 and 700 may also comprise other numbers of the slave control ICs, without being limited by the embodiments of FIG. 6 and FIG. 7.

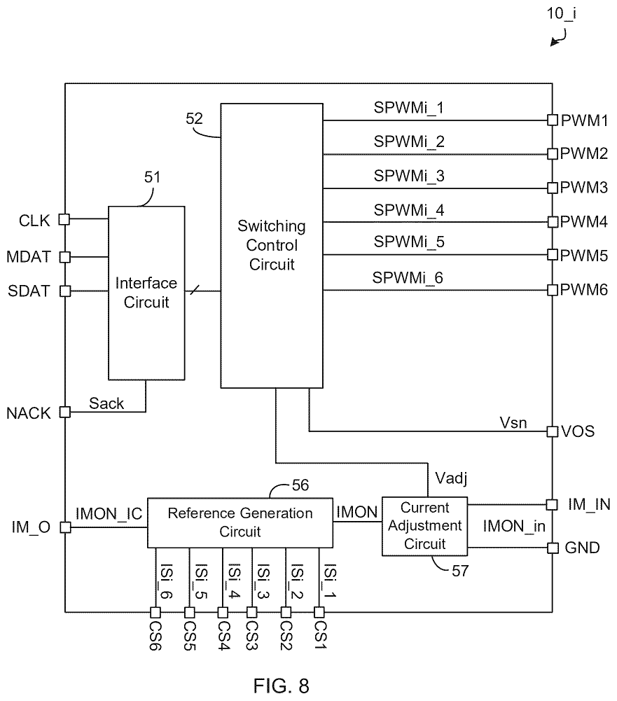

FIG. 8 schematically shows a circuit diagram of the control IC 10_i in accordance with an embodiment of the present invention. For example, the control IC 10_i shown in FIG. 8 can be used in the power supply system 100 shown in FIG. 1, the power supply system 600 shown in FIG. 6, or the power supply system 700 shown in FIG. 7, where i can be 1, 2, or 3. In the embodiment shown in FIG. 8, the control IC 10_i comprises an interface circuit 51 and a switching control circuit 52.

In one embodiment, the interface circuit 51 is coupled to the system controller 11 shown in FIG. 1 via the communication pin MDAT and the clock pin CLK to receive the commands from the system controller 11. The commands from the system controller 11 are used to configure circuit parameters. For example, the system controller 11 controls the corresponding multiphase switching converter 100i (i=1, 2, or 3), and configures enabling, a switching cycle, the output voltage target value, a startup sequence, a power off sequence, a current protection threshold, a voltage protection threshold, a temperature protection threshold, and the number of switching circuits simultaneously providing power at the same time, etc. The acknowledgment control pin NACK is coupled to the interface circuit 51 to transmit or receive the acknowledgment control signal Sack. The interface circuit 51 provides the commands from the system controller 11 to the switching control circuit 52 in response to the first state of the acknowledgment control signal Sack. The switching control circuit 52 further configures the relevant circuit parameters based on the received commands and adjusts the switching control signals SPWMi_1-SPWMi_6 accordingly. In one embodiment, when the control IC 10_i is configured as the master control IC, the interface circuit 51 is further coupled to the system controller 11 via the communication pin SDAT. In response to the first state of the acknowledgment control signal Sack, the interface circuit 51 transmits the acknowledgment code to the system controller 11 via the communication pin SDAT to respond to the commands from the system controller. In response to the second state of the acknowledgment control signal Sack, the interface circuit 51 transmits the error code to the system controller 11 via the communication pin SDAT to respond to the commands from the system controller.

In one embodiment, the control IC 10_i works together with other control ICs to control the plurality of multiphase switching converters (i.e., the multiphase switching converter 100i and other multiphase switching converters controlled by the other control ICs) to provide the output voltage Vo together. During a period when the multiphase switching converter 100i provides power under the control of the control IC 10_i, the switching control circuit 52 further provides the plurality of switching control signals SPWMi_1-SPWMi_6 based on the voltage sense signal Vsn received at the output voltage sense pin VOS. In one embodiment, the system controller 11 sends the commands to set the output voltage target value of the power supply system where the control chip 10_i is located, the switch control circuit 52 further provides the plurality of switching control signals SPWMi_1-SPWMi_6 based on the commands from the system controller 11 to control the output voltage Vo equal to the output voltage target value. In some examples, the switching control circuit 52 may employ control schemes such as a constant on-time control, an adaptive on-time control, a peak current control, or a voltage control.

In the embodiment shown in FIG. 8, the control IC 10_i further comprises the current feedback pin IM_IN, the current reference pin IM_O, the reference ground pin GND, a reference generation circuit 56, and a current adjustment circuit 57. The reference generation circuit 56 is coupled to the phase current sense pins CS1-CS6 and provides the total current signal at the current reference pin IM_O based on the plurality of current sense signals ISi_1-ISi_6 received by the phase current sense pins CS1-CS6. For example, but not limited to, the total current signal may be generated based on one of the plurality of current sense signals ISi_1-ISi_6, a sum of the plurality of current sense signals ISi_1-ISi_6, or an average of the plurality of current sense signals ISi_1-ISi_6. When the control IC 10_i is configured as the master control IC, it provides the total current signal via the current reference pin IM_O as the reference output signal IMON_out provided to the other control ICs (i.e., the slave control ICs). In one embodiment, the reference generation circuit 56 provides a sum signal IMON to the current adjustment circuit 57 based on the sum of the plurality of current sense signals ISi_1-ISi_6. When the control IC 10_i is configured as the slave control IC, it further receives the reference input signal IMON_in via the current feedback pin IM_IN and the reference ground pin GND. The current adjustment circuit 57 provides a current adjustment signal Vadj based on the reference input signal IMON_in and the sum signal IMON. For example, but not limited to, the current adjustment signal Vadj is generated based on a difference between the sum signal IMON and the reference input signal IMON_in. The switching control circuit 52 receives the voltage sense signal Vsn and the current adjustment signal Vadj, and further provides the plurality of switching control signals SPWMi_1-SPWMi_6 based on the voltage sense signal Vsn and the current adjustment signal Vadj, successively turning on the plurality of switching circuits 2i_1-2i_6. When the control IC 10_i is configured as the master control IC, the current adjustment circuit 57 does not operate, and the current adjustment signal Vadj is masked.

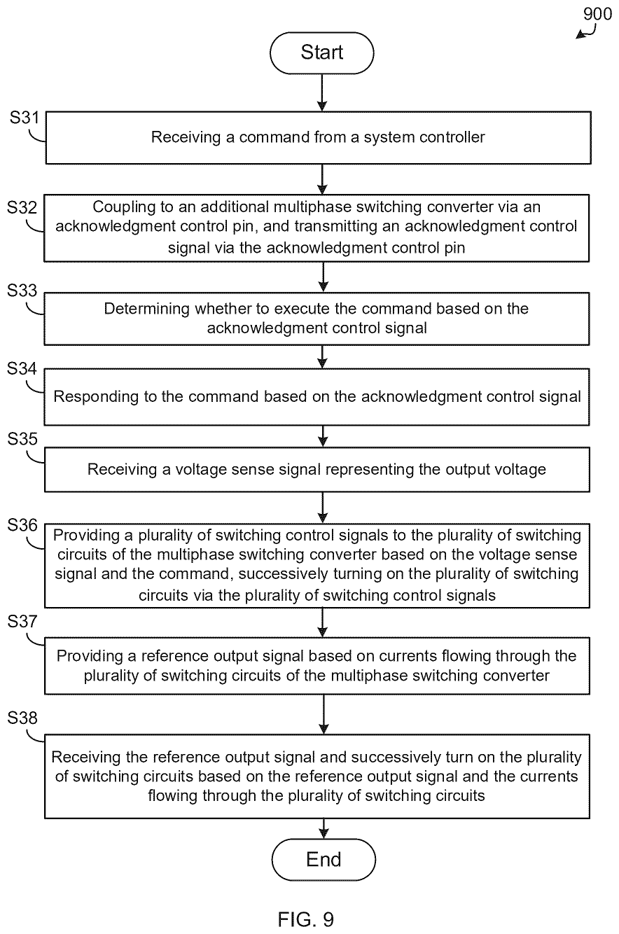

FIG. 9 shows a flowchart of a control method 900 for a multiphase switching converter in accordance with an embodiment of the present invention. The multiphase switching converter comprises a control IC and a plurality of switching circuits connected in parallel to provide an output voltage. The control method 900 comprises steps S31-S38.

In the step S31, receiving a command from a system controller. In one embodiment, the control IC receives the command from the system controller via a first communication pin.

In the step S32, coupling to an additional multiphase switching converter (e.g. an additional control IC of the additional multiphase switching converter) via an acknowledgment control pin, and transmitting an acknowledgment control signal via the acknowledgment control pin. Other control ICs are used to control other multiphase switching converters. In one embodiment, the acknowledgment control signal may be in a first state and a second state. The control IC determines whether to execute the command. If the control IC determines not to execute the command, the control IC sets the acknowledgment control signal to be in the second state via the acknowledgment control pin; otherwise, it does not change the state of the acknowledgment control signal. In one embodiment, the first state of the acknowledgment control signal may comprise being at a first voltage level, and the second state of the acknowledgment control signal may comprise being at a second voltage level.

In the step S33, determining whether to execute the command based on the acknowledgment control signal. The control IC executes the command in response to the first state of the acknowledgment control signal and does not execute the command in response to the second state of the acknowledgment control signal. In one embodiment, the control IC monitors the state of the acknowledgment control signal from a moment it begins receiving the command and stops monitoring after a preset time period. If the acknowledgment control signal remains in the first state within this preset time period, the control IC executes the command.

In the step S34, responding to the command based on the acknowledgment control signal. When configured as the master control IC, the control IC reports to the system controller that all control ICs execute the command in response to the first state of the acknowledgment control signal, and reports that all control ICs do not execute the commands in response to the second state of the acknowledgment control signal. In one embodiment, if the acknowledgment control signal remains in the first state within the preset time period, the master control IC sends an acknowledgment code to the system controller to report that all control ICs execute the commands. If the acknowledgment control signal transitions to the second state within the preset time period, the master control IC sends an error code to the system controller to report that all control ICs do not execute the command. In one embodiment, the master control IC responds to the command from the system controller via a second communication pin.

In the step S35, receiving a voltage sense signal representing the output voltage.

In the step S36, providing a plurality of switching control signals to the plurality of switching circuits of the multiphase switching converter based on the voltage sense signal and the command, successively turning on the plurality of switching circuits via the plurality of switching control signals.

In the step S37, providing a reference output signal based on currents flowing through the plurality of switching circuits of the multiphase switching converter.

In the step S38, receiving the reference output signal and successively turn on the plurality of switching circuits based on the reference output signal and the currents flowing through the plurality of switching circuits.

Note that in the control method 900 described above, the functions indicated in the boxes can also occur in a different order than those shown in FIG. 9. For example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A power supply system, comprising:
a first plurality of switching circuits, connected in parallel and a second plurality of switching circuits connected in parallel, wherein the first and second pluralities of switching circuits are configured to receive an input voltage and provide an output voltage;
a master control integrated circuit (IC), comprising:
a first voltage sense pin, configured to receive a voltage sense signal representing the output voltage;
a first plurality of switching control pins, configured to provide a first plurality of switching control signals based on the voltage sense signal to control the first plurality of switching circuits;
a first communication pin, configured to receive a command;
a second communication pin, configured to respond to the command; and
a first acknowledgment control pin; and
a slave control IC, comprising:
a second voltage sense pin, configured to receive the voltage sense signal;
a second plurality of switching control pins, configured to provide a second plurality of switching control signals based on the voltage sense signal to control the second plurality of switching circuits;
a third communication pin, configured to receive the command; and
a second acknowledgment control pin, wherein the first and second acknowledgment control pins are coupled together to transmit an acknowledgment control signal between the master control IC and the slave control IC; the master control IC is capable of determining the acknowledgment control signal via the first acknowledgment control pin, the slave control IC is capable of determining the acknowledgment control signal via the second acknowledgment control pin; wherein
the master control IC and the slave control IC are configured to execute the command in response to the acknowledgment control signal.

2. The power supply system of claim 1, wherein:
the master control IC and the slave control IC are configured to execute the command in response to a first state of the acknowledgment control signal.
when the master control IC sets the acknowledgment control signal to be in a second state via the first acknowledgment control pin representing not executing the command, the slave control IC is configured not to execute the command in response to the second state of the second acknowledgment control pin;
when the slave control IC sets the acknowledgment control signal to be in the second state via the second acknowledgment control pin representing not executing the command, the master control IC is configured not to execute the command in response to the second state of the first acknowledgment control pin.

3. The power supply system of claim 2, wherein the master control IC and the slave control IC are configured to monitor the acknowledgment control signal for a preset time period after receiving the command, wherein:
in response to that the acknowledgment control signal remains in the first state within the preset time period, the master control IC and the slave control IC are configured to execute the command; and
in response to that the acknowledgment control signal enters the second state within the preset time period, the master control IC and the slave control IC are configured not to execute the command.

4. The power supply system of claim 2, wherein:
in response to the first state of the acknowledgment control signal, the master control IC is configured to send an acknowledgment code to a system controller, indicating that both the master control IC and the slave control IC execute the command; and
in response to the second state of the acknowledgment control signal, the master control IC is configured to send an error code to the system controller, indicating that both the master control IC and the slave control IC do not execute the command.

5. The power supply system of claim 1, wherein:
in response to the acknowledgment control signal, the master control IC is further configured to send a response message via the second communication pin to report whether the master control IC and the slave control IC execute the command.

6. The power supply system of claim 1, wherein:
the master control IC is further configured to provide a reference output signal based on currents flowing through the first plurality of switching circuits; and
the slave control IC is further configured to receive the reference output signal and provide the second plurality of switching control signals based on the reference output signal to control the second plurality of switching circuits.

7. The power supply system of claim 6, wherein:
the slave control IC is configured to control the second plurality of switching circuits based on currents flowing through the second plurality of switching circuits and the reference output signal, and a total current flowing through the second plurality of switching circuits is balanced with a total current flowing through the first plurality of switching circuits.

8. A control IC of a multiphase switching converter, comprising:
a first communication pin, capable of receiving a command;
a voltage sense pin, configured to receive a voltage sense signal representing an output voltage of the multiphase switching converter;
a plurality of switching control pins, wherein the control IC is configured to output a plurality of switching control signals via the plurality of switching control pins based on the voltage sense signal to turn on and off a plurality of switching circuits of the multiphase switching converter; and
an acknowledgment control pin, capable of being coupled to an additional multiphase switching converter to transmit an acknowledgment control signal between the control IC and the additional multiphase switching converter, the control IC sets and reads a state of the acknowledgment control signal via the acknowledgment control pin; wherein
the control IC is configured to execute the command in response to the acknowledgment control signal.

9. The control IC of claim 8, wherein:
the control IC is configured to execute the command in response to a first state of the acknowledgment control signal; and
when the control IC sets the acknowledgment control signal to be in a second state via the acknowledgment control pin representing not executing the command.

10. The control IC of claim 9, wherein:
when the control IC sets the acknowledgment control signal to be in the second state, the acknowledgment control signal remains in the second state for a time period before transitioning to the first state.

11. The control IC of claim 8, further comprising a second communication pin, wherein the control IC is configured to respond to the command via the second communication pin based on the acknowledgment control signal.

12. The control IC of claim 8, further comprising:
a plurality of current sense pins, configured to receive a plurality of current sense signals, wherein the plurality of current sense signals represent currents flowing through the plurality of switching circuits; and
a current reference pin, configured to provide a reference output signal based on the currents flowing through the plurality of switching circuits.

13. The control IC of claim 8, further comprising:
a plurality of current sense pins, configured to receive a plurality of current sense signals, wherein the plurality of current sense signals represent currents flowing through the plurality of switching circuits; and
a current feedback pin, configured to receive a reference output signal, and successively turn on and off the plurality of switching circuits based on the plurality of current sense signals and the reference output signal.

14. A control method for a multiphase switching converter, comprising:
receiving a voltage sense signal representing an output voltage;
receiving a command from a system controller;
coupling to an additional multiphase switching converter and transmitting an acknowledgment control signal via an acknowledgment control pin;
determining whether to execute the command based on the acknowledgment control signal; and
providing a plurality of switching control signals to a plurality of switching circuits of the multiphase switching converter based on the voltage sense signal and the command, successively turning on the plurality of switching circuits via the plurality of switching control signals.

15. The control method of claim 14, further comprising:
responding to the command based on the acknowledgment control signal.

16. The control method of claim 15, wherein responding to the command based on the acknowledgment control signal further comprises:
in response to a first state of the acknowledgment control signal, sending an acknowledgment code to the system controller, indicating that all control ICs execute the command; and
in response to a second state of the acknowledgment control signal, sending an error code to the system controller, indicating that all the control ICs do not execute the command.

17. The control method of claim 14, further comprising:
executing the command in response to a first state of the acknowledgment control signal; and
setting the acknowledgment control signal to be in a second state via the acknowledgment control pin representing not executing the command.

18. The control method of claim 14, wherein determining whether to execute the command based on the acknowledgment control signal further comprises:
executing the command in response to a first state of the acknowledgment control signal; and
not executing the command in response to a second state of the acknowledgment control signal.

19. The control method of claim 14, further comprising:
providing a reference output signal based on currents flowing through the plurality of switching circuits of the multiphase switching converter.

20. The control method of claim 14, further comprising:
receiving a reference output signal and successively turn on the plurality of switching circuits based on the reference output signal and currents flowing through the plurality of switching circuits.
